(19) United States
(12) Patent Application Publication
(10) Pub. No.: US 2007/0127173 A1
(43) Pub. Date: Jun. 7, 2007

(54) ELECTROSTATIC DISCHARGE PROTECTION APPARATUS FOR HIGH-VOLTAGE PRODUCTS

(76) Inventor: Chyh-Yih Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,495

(22) Filed: Mar. 30, 2006

(30) Foreign Application Priority Data
Dec. 6, 2005 (TW) 94142907

(51) Int. Cl. H02H 9/00

(52) U.S. Cl. 361/56

(57) ABSTRACT

An electrostatic discharge (ESD) protection apparatus for high-voltage products is provided. The ESD protection apparatus includes a resistor, a capacitor, a first transistor, n diodes, and a main transistor, wherein n is an integer greater than 0. The holding voltage of the provided ESD protection apparatus is adjusted by determining the n value. The adjusted holding voltage is higher than the system voltage under normal operation, so that latch-up issues are avoided.

### CROSS-REFERENCE TO RELATED APPLICATION

This application claims the priority benefit of Taiwan application Ser. No. 94142907, filed on Dec. 6, 2005. All disclosure of the Taiwan application is incorporated herein by reference.

### BACKGROUND OF THE INVENTION

1. Field of Invention

The present invention relates to an electrostatic discharge (ESD) protection apparatus, more particularly, to an ESD protection apparatus for high-voltage products.

2. Description of Related Art

Many integrated circuit products for specific applications (such as, display driver, power supply, electrical management, telecommunication, automobile electronics, and industrial control, etc.) often require high-voltage signal to communicate with system. The voltage level of the high-voltage signal is usually higher than 8 Volts, or even higher than 40 Volts. Therefore, integrated circuit products are formed by high-voltage elements in a high-voltage process. However, as the high-voltage elements have a high junction breakdown voltage, they have relatively poor ESD tolerance.

To prevent integrated circuit products from being damaged by ESD, an ESD clamp circuit conducted with high efficiency must be bridged between power rails. FIG. 1 is a schematic view of the basic ESD protection of an ESD protection apparatus with power rails. In FIG. 1, an ESD protection apparatus 130 is bridged between the power rails VDD and VSS. In addition, an ESD diode is usually arranged between each pad and each power rail VDD, VSS. For example, in FIG. 1, an ESD diode Dp1 is coupled between a pad 110 and the power rail VDD, and an ESD diode Dn1 is coupled between the pad 110 and the power rail VSS. Therefore, when the pad 110 generates a positive ESD impulse, the impulse will be conducted into the power rail VDD via the ESD diode Dp1; on the contrary, when the pad 100 generates a negative ESD impulse, the impulse will be conducted into the power rail VSS via the ESD diode Dn1. Likewise, as for a pad 140, the ESD impulse is conducted into the power rail VDD or VSS via the ESD diodes Dp2 and Dn2.

When the pad 110 generates an ESD impulse and the pad 140 is grounded, the ESD current will be conducted to the power rail VDD via a forward-biased ESD diode Dp1. The ESD current on the power rail VDD will be released to the power rail VSS via the high efficient ESD protection apparatus 130. Finally, the ESD current will be conducted to the grounded pad 140 via the forward-biased ESD diode Dn2. In FIG. 1, the discharging path of the ESD current is indicated by the bold black line.

By using the above ESD protection design, the ESD diodes can be operated in a forward-biased state so as to conduct the ESD current. The diodes operated in a forward-biased state can withstand a relatively high ESD level within a small element area. Then, the ESD protection circuit at the pad terminal can be realized with a small area, thereby reducing the cost. Therefore, if the ESD protection apparatus with power rails can be conducted in time when the ESD event occurs, the ESD clamp circuit conducted with high efficiency can increase the ESD tolerance of the integrated circuit products. When the integrated circuit is under normal operation, the ESD protection apparatus with power rails must be kept in an open state, so as to avoid current leakage. Furthermore, the holding voltage of the main ESD element in the ESD protection apparatus with power rails must be higher than that of VDD; in this way, even if the ESD protection apparatus with power rails is triggered by accident, latch-up issues still can be avoided.

FIG. 2 is a circuit diagram of the ESD protection apparatus with power rails according to U.S. Patent Publication No. 5,744,842. Referring to FIG. 2, the ESD protection apparatus includes an ESD transient detection circuit 102 and an N-type field-oxide device 100. The ESD transient detection circuit 102 includes a resistor/capacitor (R/C) network and an NOT gate 104. The R/C network has a delay constant, which is greater than the ESD impulse time while smaller than the VDD power-on rise time.

The field-oxide device 100 is the main ESD element for conducting sufficient amount of ESD current. The output of the ESD transient detection circuit 102 is coupled to the substrate of the field-oxide device 100. Therefore, the field-oxide device 100 can be considered as a parasitic bipolar junction transistor (BJT). The base of the parasitic BJT is coupled to the output of the NOT gate 104, while the collector and emitter of the BJT are respectively coupled to VDD and VSS.

As the delay constant of the R/C network is greater than the ESD impulse time, when the ESD impulse reaches the VDD while the VSS is correspondingly grounded, the input end of the NOT gate 104 still remains at a low voltage level. Therefore, the output of the NOT gate 104 is raised to a high voltage level due to the initial ESD current of the power rail VDD. Meanwhile, the initial ESD current also triggers the parasitic BJT of the field-oxide device 100 via the NOT gate 104. Then, the main ESD current on the power rail VDD passes through the parasitic BJT to reach the power rail VSS.

The N-type field-oxide device manufactured through a 40V CMOS process is provided with a holding voltage lower than the system voltage VDD (40 V), as shown in FIG. 3. As can be seen from FIG. 3, when the voltage between VDD and VSS is greater than about 44 V, the main ESD element of the ESD protection apparatus (i.e., the field-oxide device 100) is triggered. The triggered ESD protection apparatus will be latched up at its holding voltage (about 17 V-25 V). As the holding voltage is lower than the system voltage VDD (40 V), latch-up issues will occur if the field-oxide device 100 is triggered by accident. Therefore, the conventional ESD protection apparatus with power rails cannot be applied to a high-voltage process, as it cannot avoid the latch-up issues.

FIG. 4 is a circuit diagram of the ESD protection apparatus with power rails according to U.S. Patent Publication No. 6,552,886. Referring to FIG. 4, the ESD protection apparatus includes an R/C network consisting of a P-type metal oxide semiconductor (PMOS) transistor 16 and a capacitor 18, three NOT gates 20, and an N-type metal oxide semiconductor (NMOS) transistor 22. The transistor 16 is served as a resistor by connecting its gate to the ground. The operation of this conventional technique is similar to that of the conventional technique in FIG. 2, and it still cannot solve the latch-up issues when being applied to high-voltage products.

FIG. 5 is a circuit diagram of another ESD protection apparatus with power rails according to U.S Patent Publication No. 6,552,886. Referring to FIG. 5, in the ESD protection apparatus, a transistor 39 is used to feedback the signal of the node S3 to the node S2, for keeping the transistor 30 in a cutoff state under a normal operation. However, this conventional technique still cannot solve the latch-up issues when being applied to high-voltage products.

FIG. 6 is a circuit diagram of the ESD protection apparatus according to U.S. Patent Publication No. 6,690,067. Referring to FIG. 6, the ESD protection apparatus includes a double-gate BJT architecture. Compared with the conventional technique of FIG. 2, the conventional technique of FIG. 6 has a similar operation, except that the base of the parasitic BJT is wider. The conventional technique of FIG. 6 still cannot solve the latch-up issues when being applied to high-voltage products.

FIG. 7 is a circuit diagram of the ESD protection apparatus according to U.S. Patent Publication No. 6,671,153. Referring to FIG. 7, the conventional technique discloses an ESD clamp circuit with small current leakage at the power supply terminal. In the present patent, the main ESD current enters the power rail VSS via a parasitic silicon controlled rectifier (SCR), NCLSCR, and diode strings D1-Dn. The holding voltage of the ESD clamp circuit can be adjusted by changing the number of the diodes connected in series in the diode strings D1-Dn. However, a large circuit area is required in the conventional technique, thus, the cost is increased.

### SUMMARY OF THE INVENTION

The object of the present invention is to provide an ESD protection apparatus. The holding voltage of the ESD protection apparatus is adjusted by determining the number of the diodes connected in series in the main ESD path, so as to avoid latch-up issues.

Based on the above and other objects, an ESD protection apparatus is provided. The ESD protection apparatus includes a resistor, a capacitor, a first transistor, n diodes, and a main transistor, wherein n is an integer greater than 0. The capacitor and the resistor are connected with each other in series between a first power rail and a second power rail. The gate of the first transistor is coupled to the common contact of the capacitor and the resistor, while the source and the drain of the first transistor are respectively coupled to the first power rail and the substrate of the main transistor. The main transistor and the above diodes are connected with each other in series between the first power rail and the second power rail. The holding voltage of the ESD protection apparatus can be adjusted by determining the n value.

According to the present invention, as multiple diodes are connected in series in the main ESD path, the holding voltage of the ESD protection apparatus can be adjusted by determining the number of the diodes connected in series. By adjusting the holding voltage of the ESD protection apparatus to be higher than the voltage of the power rails under a normal operation, the ESD protection apparatus of the present invention can be applied to high-voltage products to avoid latch-up issues.

In order to make the aforementioned and other objects, features and advantages of the present invention comprehensible, preferred embodiments accompanied with figures are described in detail below.

### BRIEF DESCRIPTION OF THE DRAWINGS

FIG. 1 is a schematic view of the basic ESD protection of an ESD protection apparatus with power rails.

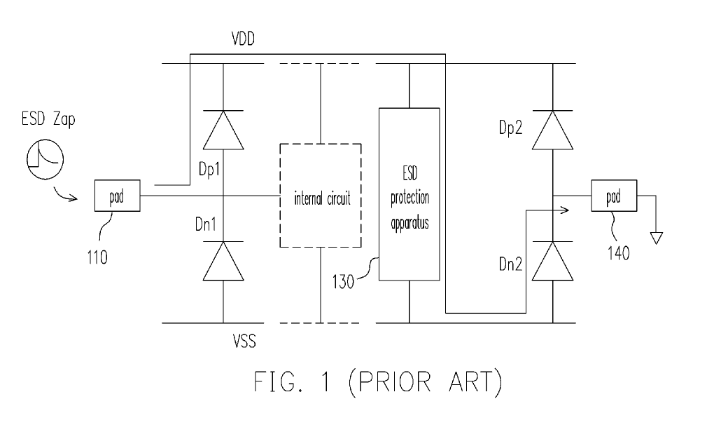

FIG. 2 is a circuit diagram of the ESD protection apparatus with power rails according to U.S. Patent Publication No. 5,744,842.

FIG. 3 illustrates the holding voltage of the N-type field-oxide device manufactured by a 40 V CMOS process, wherein the holding voltage is lower than the system voltage VDD (40 V).

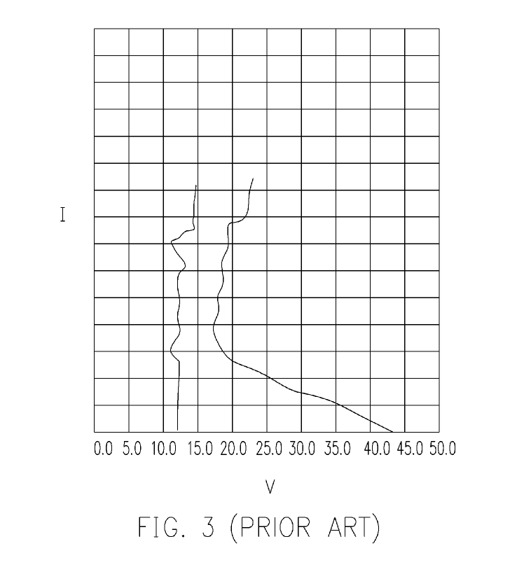

FIG. 4 is a circuit diagram of the ESD protection apparatus with power rails according to U.S. Patent Publication No. 6,552,886.

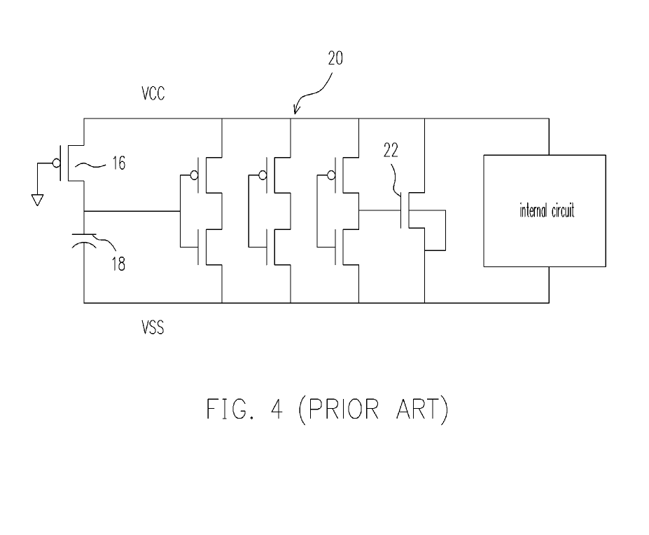

FIG. 5 is a circuit diagram of another ESD protection apparatus with power rails according to U.S. Patent Publication No. 6,552,886.

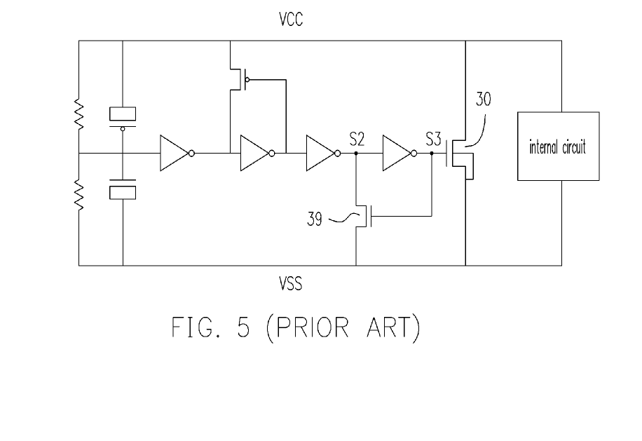

FIG. 6 is a circuit diagram of the ESD protection apparatus according to U.S. Patent Publication No. 6,690,067.

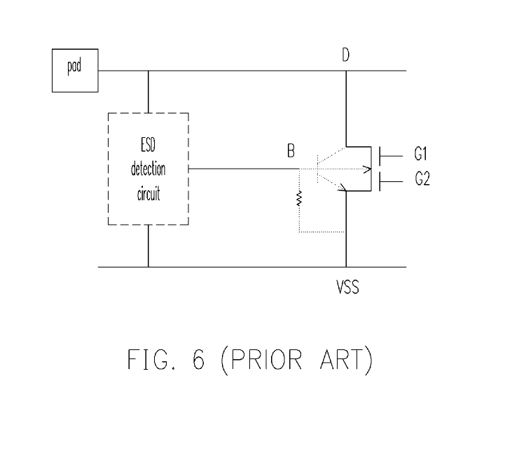

FIG. 7 is a circuit diagram of the ESD protection apparatus according to U.S. Patent Publication No. 6,671,153.

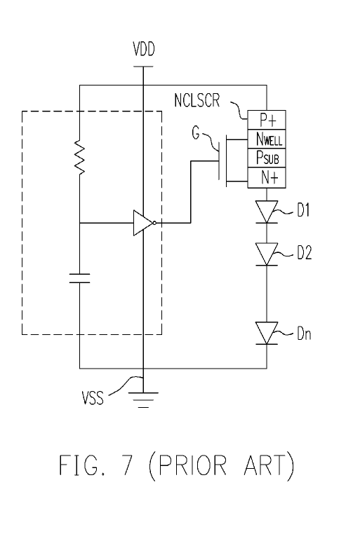

FIG. 8 is a circuit diagram of the ESD protection apparatus for high-voltage products according to one embodiment of the present invention.

FIG. 9 is a voltage-current relationship graph of raising the holding voltage of the ESD protection apparatus in high-voltage applications according to one embodiment of the present invention.

FIG. 10 is a circuit diagram of the ESD protection apparatus for high-voltage products according to another embodiment of the present invention.

### DESCRIPTION OF EMBODIMENTS

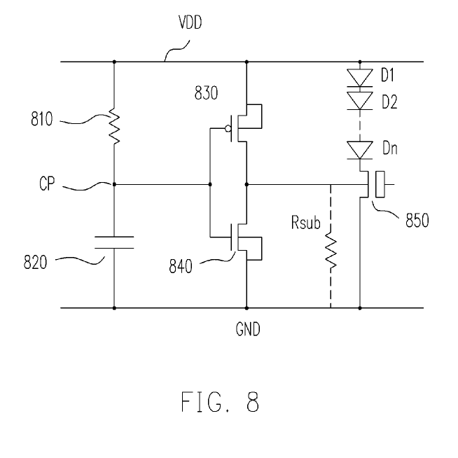

FIG. 8 is a circuit diagram of the ESD protection apparatus for high-voltage products according to the embodiments of the present invention. Referring to FIG. 8, the ESD protection apparatus includes a resistor 810, a capacitor 820, a first transistor 830, a second transistor 840, diodes D1-Dn, and a main transistor 850, wherein n is an integer greater than 0. In the embodiment, the transistors 830 and 840 are a PMOS transistor and an NMOS transistor respectively, and the main transistor 850 is an N-type field-oxide device. In general, the substrate of the main transistor 850 has a substrate-internal resistor (indicated as a resistor Rsub in FIG. 8), wherein the substrate of the main transistor 850 is coupled to the second power rail GND (as the ground line here) via the substrate-internal resistor Rsub.

The capacitor 820 and the resistor 810 are connected with each other in series between the first power rail VDD (as the system voltage line) and the second power rail GND. The gates of the transistors 830 and 840 are coupled to the common contact CP between the capacitor 820 and the resistor 810. The source and the drain of the transistor 830 are respectively coupled to the first power rail VDD and the substrate of the main transistor 850. The drain of the transistor 840 is coupled to the drain of the transistor 830, while the source of the transistor 840 is coupled to the second power rail GND. In this embodiment, the substrate of the first transistor 830 is coupled to the first power rail VDD, while the substrate of the second transistor 840 is coupled to the second power rail GND.

In the embodiment, the gate of the main transistor 850 is a floating gate. In the main transistor 850, its drain, substrate, and source constitute a parasitic NPN BJT, i.e., the drain, the substrate, and the source of the main transistor 850 are respectively coupled to the collector, the base, and the emitter of the parasitic NPN BJT. The R/C network consisting of the resistor 810 and the capacitor 820 has a delay time constant, which is greater than the ESD impulse time but smaller than the power-on rise time of the first power rail VDD (as the system voltage line here). When the ESD impulse reaches the first power rail VDD and the second power rail GND is grounded correspondingly, as the aforementioned R/C network has a relatively long delay time constant, the gates of the transistors 830 and 840 are still kept at a low voltage level. Therefore, the first transistor 830 is turned on while the second transistor 840 is still kept in an off state. The initial current of the ESD flows into the substrate of the main transistor 850 (i.e., the base of the parasitic BJT) via the first transistor 830, and then, the initial current of the ESD flows into the second power rail GND (as the ground line here) via the substrate-internal resistor Rsub. Meanwhile, the aforementioned initial current of the ESD triggers the parasitic BJT (i.e., turning on the main transistor 850) by raising the base voltage of the parasitic BJT. Then, the main ESD current on the first power rail VDD passes through the diodes D1-Dn and the main transistor 850 to reach the second power rail GND.

The main transistor 850 and the diodes D1-Dn are connected with each other in series between the first power rail VDD and the second power rail GND. The main transistor 850 and the diodes D1-Dn connected in series form a main ESD path. In the main ESD path, the diodes D1-Dn provide sufficient clamp voltage for the high-voltage power supply. The desired clamp voltage is adjusted by determining the n value of the diodes D1-Dn. When the ESD occurs, the diodes D1-Dn will be operated in a forward-biased configuration. Therefore, the element area of the diodes D1-Dn can be designed as small as possible.

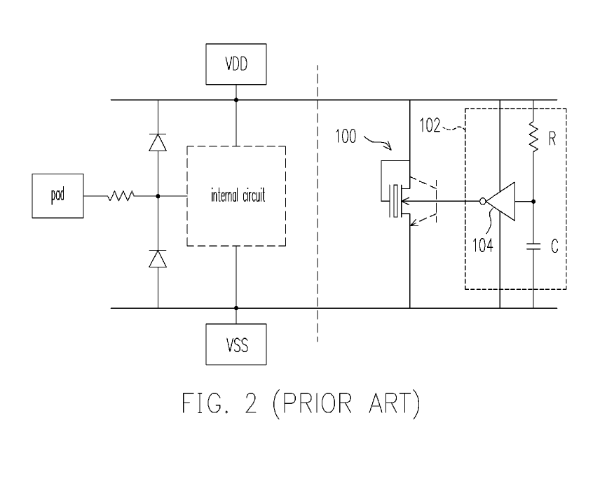

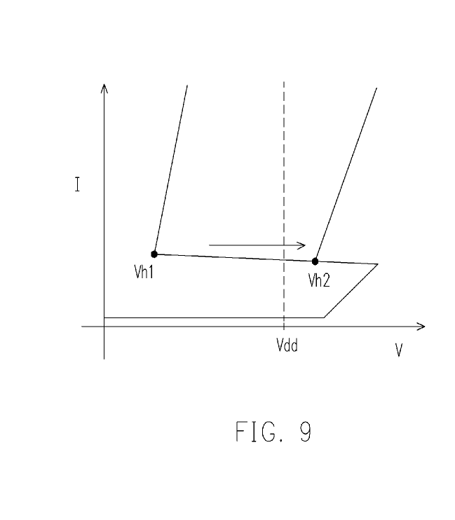

FIG. 9 is a voltage-current relationship graph of raising the holding voltage of the ESD protection apparatus in high-voltage applications according to the embodiment of the present invention. Referring to FIG. 9, as for the conventional technique (for example, the conventional technique shown in FIG. 2), in a high-voltage CMOS process, as the holding voltage Vh1 of the field-oxide device is lower than the system voltage Vdd, latch-up issues will occur if the field-oxide device is triggered by accident. Therefore, the conventional ESD protection apparatus cannot be applied to high-voltage products as it cannot prevent latch-up issues. Compared with the conventional technique, the holding voltage of the ESD protection apparatus can be adjusted in the present embodiment by determining the number of the diodes (for example, the diodes D1-Dn in FIG. 8), such that the holding voltage of the ESD protection apparatus is raised to Vh2. In this embodiment, as the holding voltage Vh2 of the ESD protection apparatus is higher than the system voltage Vdd, latch-up issues will not occur even if the field-oxide device is triggered by accident.

In the above embodiment, the number n of the diodes D1-Dn is an integer greater than 0 (for example, one, two, three, or more). The holding voltage of the ESD protection apparatus is adjusted by determining the n value of the diodes D1-Dn, i.e., the number of the diodes D1-Dn can be increased by the designer according to the requirements, thereby raising the holding voltage Vh2 of the ESD protection apparatus.

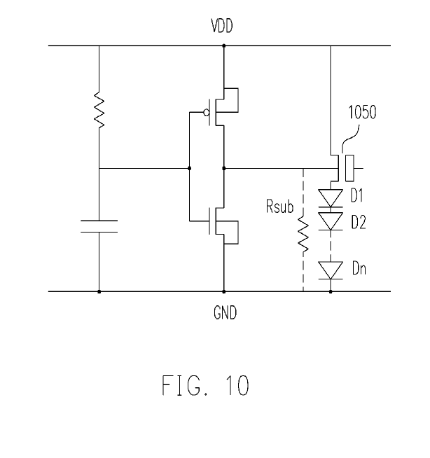

Moreover, the connecting sequence of the diodes D1-Dn and the main transistor 850 is not limited to what is shown in FIG. 8. The diodes can be connected in series between the main transistor and the first power rail, and/or connected in series between the main transistor and the second power rail. FIG. 10 is a circuit diagram of the ESD protection apparatus for high-voltage products according to another embodiment of the present invention. Referring to FIG. 10, the ESD protection apparatus is similar to that shown in FIG. 8, thus, its operations will not be described any more herein. The difference between FIG. 10 and FIG. 8 is that: the diodes D1-Dn are connected in series between the main transistor 1050 and the second power rail GND. In the ESD protection apparatus of FIG. 10, the holding voltage of the ESD protection apparatus can be adjusted by determining the n value of the diodes D1-Dn, such that latch-up issues will not occur in the embodiment even if the field-oxide device is triggered by accident.

In view of the above, as for the conventional technique, since the holding voltage of the field-oxide device is lower than the system voltage in a high-voltage CMOS process, latch-up issues will occur if the conventional ESD protection apparatus is triggered by accident; therefore, the conventional ESD protection apparatus cannot be applied to high-voltage products. Compared with the conventional technique, the holding voltage of the ESD protection apparatus can be adjusted by determining the number of the diodes (for example, the diodes D1-Dn in FIG. 8 or FIG. 10) according to the present invention. The adjusted holding voltage is higher than the system voltage, such that latch-up issues will not occur in the present invention.

Though the present invention has been disclosed above by the preferred embodiments, it is not intended to limit the invention. Anybody skilled in the art can make some modifications and variations without departing from the spirit and scope of the invention. Therefore, the protecting range of the invention falls in the appended claims.

What is claimed is:

1. An electrostatic discharge (ESD) protection apparatus, comprising:
a resistor;
a capacitor, connected in series with the resistor between a first power rail and a second power rail;
a first transistor, wherein the gate of the first transistor is coupled to the common contact between the capacitor and the resistor, and a first source/drain of the first transistor is coupled to the first power rail;
n diodes, wherein n is an integer greater than 0; and
a main transistor, connected in series with the above diodes between the first power rail and the second power rail, wherein the substrate of the main transistor is coupled to a second source/drain of the first transistor;
wherein, the holding voltage of the ESD protection apparatus is adjusted by determining the n value.

2. The ESD protection apparatus as claimed in claim 1, wherein the substrate of the main transistor has a substrate-internal resistor, and the substrate of the main transistor is further coupled to the second power rail via the substrate-internal resistor.

3. The ESD protection apparatus as claimed in claim 1, wherein the gate of the main transistor is a floating gate.

4. The ESD protection apparatus as claimed in claim 1, wherein the main transistor is an N-type field-oxide device.

5. The ESD protection apparatus as claimed in claim 1, wherein the substrate of the first transistor is coupled to the first power rail.

6. The ESD protection apparatus as claimed in claim 1, wherein the first transistor is a P-type metal oxide semiconductor (PMOS) transistor.

7. The ESD protection apparatus as claimed in claim 1, further comprising:
a second transistor, wherein the gate of the second transistor is coupled to the common contact between the capacitor and the resistor; the first source/drain of the second transistor is coupled to the second source/drain of the first transistor; and the second source/drain of the second transistor is coupled to the second power rail.

8. The ESD protection apparatus as claimed in claim 7, wherein the substrate of the second transistor is coupled to the second power rail.

9. The ESD protection apparatus as claimed in claim 7, wherein the second transistor is an N-type metal oxide semiconductor (NMOS) transistor.

10. The ESD protection apparatus as claimed in claim 1, wherein the first power rail and the second power rail are the system voltage line and the ground line respectively.
